(19) United States
(12) Patent Application Publication
(10) Pub. No.: US 2023/0047295 A1
(43) Pub. Date: Feb. 16, 2023

(54) WORKLOAD PERFORMANCE PREDICTION AND REAL-TIME COMPUTE RESOURCE RECOMMENDATION FOR A WORKLOAD USING PLATFORM STATE SAMPLING

(71) Applicant: Intel Corporation, Santa Clara, CA (US)

(72) Inventors: Javier Martinez, El Dorado Hills, CA (US); Madhura Chaterjee, Bangalore (IN); Michael Rosenzweig, Queen Creek, AZ (US)

(73) Assignee: Intel Corporation, Santa Clara, CA (US)

(21) Appl. No.: 17/973,321

(22) Filed: Oct. 25, 2022

(51) Int. Cl. G06F 9/50; G06F 11/34

(52) U.S. Cl. CPC G06F 9/505; G06F 11/3409

(57) ABSTRACT

Embodiments described herein are generally directed to improving predictions regarding workload performance to facilitate dynamic auto device selection. In an example, based on telemetry samples collected from a computer system in real-time and indicative of a state of the computer system, one or more workload performance prediction models are built or updated for a heterogeneous set of computer resources of the computer system with reference to one or more optimization goals. At a time of execution of a workload, a particular computer resource of the heterogeneous set of computer resources on which to dispatch the workload is dynamically determined by: (i) generating multiple predicted performance scores each corresponding to one of the computer resources based on the state of the computer system and the one or more workload performance prediction models; and (ii) selecting the particular computer resource based on the predicted performance scores.

### TECHNICAL FIELD

Embodiments described herein generally relate to the field of heterogeneous computing and, more particularly, to prediction of workload performance and dynamic determination of a computer resource selection for a given workload using platform state sampling.

### BACKGROUND

Heterogeneous computing refers to computer systems that use more than one kind of processor or core. Such computer systems gain performance and/or energy efficiencies by incorporating a heterogeneous set of computer resources (e.g., zero or more central processing units (CPUs), zero or more integrated or discrete graphics processing units (GPUs), and/or zero or more vision processing units (VPUs)) for performing various tasks (e.g., machine-learning (ML) inferences). When multiple capable computer resources are available to perform work, it is desirable to be able to use them effectively. This creates the challenge of determining the best one to use depending on the situation (e.g., the nature of the workload and the system state, which is constantly changing).

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is a block diagram illustrating a recommendation system and external interactions according to some embodiments.

FIG. 2 is a high-level flow diagram illustrating operations for performing workload performance prediction and recommendation according to some embodiments.

FIG. 3 is a block diagram illustrating an internal design according to some embodiments.

FIG. 4 is a flow diagram illustrating operations for performing collection of telemetry data according to some embodiments.

FIG. 5 is a flow diagram illustrating operations for performing computer resource performance prediction according to some embodiments.

FIG. 6 is a graph illustrating an example of regression of computer-resource-specific samples to predict an optimization goal based on a state of a computer system according to some embodiments.

FIG. 7 is a flow diagram illustrating operations for performing computer resource recommendation according to some embodiments.

FIG. 8 is an example of a computer system with which some embodiments may be utilized.

### DETAILED DESCRIPTION

Embodiments described herein are generally directed to improving predictions regarding workload performance to facilitate dynamic auto device selection. As noted above, computer system platforms may have a heterogeneous set of computer resources for performing various tasks. Developers often make device selection using fixed heuristics, for example, it may be assumed that a GPU is always the most powerful device or profiling may be performed during a first run to aid selection for a subsequent run. In other cases, the decision is left to the user who is less familiar with the implications of the decision. Very little has been done to improve the device selection process. Frameworks such as CoreML by Apple and WinML by Microsoft have enumerations that applications can use to delegate device selection. However, when using such delegation, the behavior can be suboptimal since either simple heuristics are used to select a particular device regardless of the application workload at issue or device capabilities (WinML) or the heuristics are based on the application workload with no consideration given to system load (CoreML). As a result, while developers have a few options to delegate device selection, those options currently available do not improve user experience in complex scenarios, for example, multitasking scenarios in which multiple applications compete for computer resources and/or transitioning power mode scenarios in which the computer system may be plugged in, on battery, low battery, etc.

Various embodiments described herein seek to address or at least mitigate some of the limitations of existing frameworks by providing a recommendation system that execution frameworks can use to include input from hardware vendors in the device selection process. Additionally, the proposed approach can minimize resource underutilization, maximize concurrency, and expose various device selection targets. For a workload, at any given time, finding the optimal device on the platform that can deliver the required performance without compromise and, at the same time, with lowest overhead is a complex optimization problem. This is largely because other processes (ML or non-ML) may also be using the platform's computer resources in unpredictable ways. Furthermore, deploying a workload on any platform device changes the dynamic and adds additional complexity. At a high level, the optimal device for a given workload at any given time depends on three main factors: (i) the state of the system (including availability of devices), (ii) device characteristics (e.g., frequency, memory, etc.), and (iii) the application requirements (e.g., latency and throughput).

As described further below, the proposed recommendation system is an innovative solution that consists of several modules to enable, quantify, and utilize these factors to find the optimal device at any given time for a workload. For example, the recommendation system may first detect all the existing devices on the platform and thereafter dynamically monitor their respective utilization and availability. Second, the performance of the workload on participating devices may be estimated. In the context of an ML workload, this may be accomplished (e.g., initially) with an innovative cost model that evaluates the network associated with the ML workload as well as device characteristics and availability. Finally, heuristics may be used to map the expected performance of the devices to the application requirement to determine the optimal device for the workload. This process may then be repeated continuously to identify the ideal device at any given time and for any active workload.

According to one embodiment, telemetry samples may be collected in real-time from a computer system having a heterogeneous set of computer resources in which the telemetry samples are indicative of a state of the computer system (e.g., utilization of the individual computer resources). Based on the telemetry samples, one or more workload performance prediction models (e.g., a cloud-based federated learning model, a local statistical model, a local machine-learning model, and/or a network-based synthetic model) may be created or updated for a heterogeneous set of computer resources of the computer system with reference to one or more optimization goals (e.g., minimizing or maximizing one or more of performance, power, latency, throughput, etc.). At a time of execution of a workload, a particular computer resource of the heterogeneous set of computer resources on which to dispatch the workload may be dynamically determined based on workload performance predictions for the computer resources. For example, multiple predicted performance scores may be generated each corresponding to a computer resource of the heterogeneous set of computer resources based on the state of the computer system and the one or more workload performance prediction models; and the particular computer resource may be selected based on the predicted performance scores.

In the following description, numerous specific details are set forth in order to provide a thorough understanding of example embodiments. It will be apparent, however, to one skilled in the art that embodiments described herein may be practiced without some of these specific details.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, a “workload” generally refers to an application and/or what the application runs based on the context in which the term is used. A workload may be a machine-learning (ML) workload or a non-ML workload.

As used herein, a “state” of a computer system generally refers to a status of a computer system, the status of computer resources of the computer system, and/or an individual computer resource of the computer system that affects workload performance. Non-limiting examples of state include availability, utilization, battery status, power consumption, thermal conditions, and clock frequency).

The terms “component”, “platform”, “system,” “unit,” “module” and the like as used herein are intended to refer to a computer-related entity, either a software-executing general purpose processor, hardware, firmware, or a combination thereof. For example, a component may be, but is not limited to being, a process running on a computer resource, an object, an executable, a thread of execution, a program, and/or a computer.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability and mobility (e.g., cloud bursting for load balancing between clouds).

### Example Operational Environment

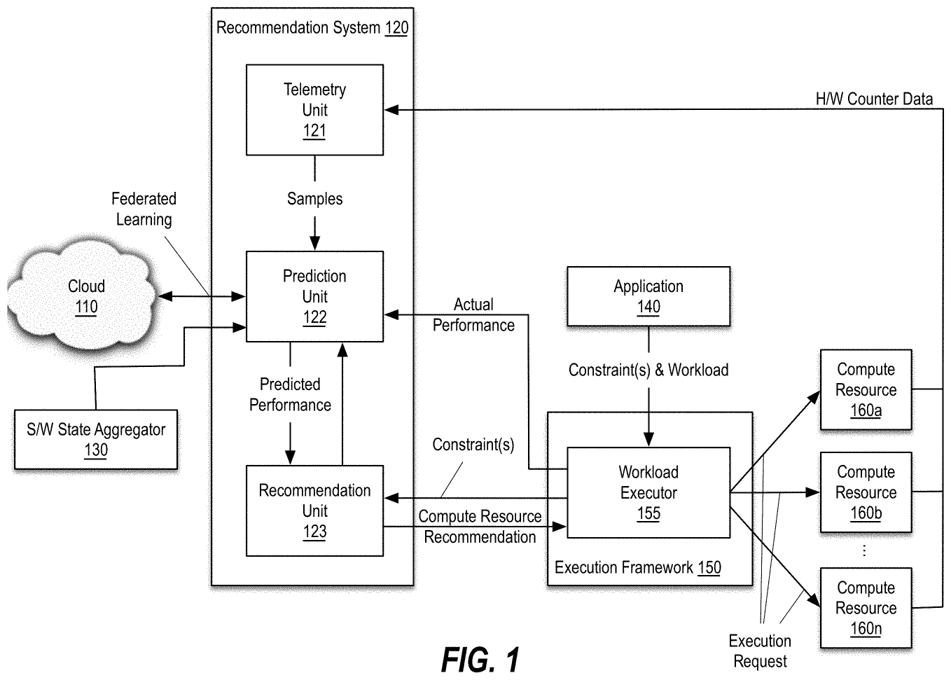

FIG. 1 is a block diagram illustrating a recommendation system 120 and external interactions according to some embodiments. As a brief overview, in various embodiments, the recommendation system 120 collects telemetry samples, hardware properties of devices of a heterogeneous computer system, software state, and workload performance in real time to build a device-workload specific model. When a request for a device recommendation is received by the recommendation system 120, the recommendation system 120 may use recent hardware properties to query a federated learning model from the cloud (e.g., cloud 110) as well as one or more local models to predict workload performance for each of the devices. Upon completion of a given workload, the actual workload performance may be fed back to the recommendation system 120 and the cloud to generate more samples and correct mispredictions.

In the context of the present example, the recommendation system 120 interacts with external entities, including a cloud 110, a software (S/W) state aggregator 130, an execution framework 150, and a heterogeneous set of computer resources (e.g., computer resources 160a-n). The software state aggregator 130 may be responsible for collecting system state, for example, outside of the framework, related to computer resource selection (e.g., power policy (battery saver, high performance), battery state (plugged, unplugged), network connection type (metered or not), etc.).

The execution framework 150 represents a workload execution framework for deploying workloads on computer resources (e.g., computer resources 160a-n). For example, a workload executor 155 of the execution framework 150 may receive workload requests, including the workload and specified constraints for the workload, from the application 140 and may cause the workload to be deployed to a computer resource based on a computer resource recommendation received from the recommendation system 120. In the context of ML, a non-limiting example of the execution framework 150 is the OpenVINO toolkit for optimizing and deploying artificial intelligence (AI) inference. It is to be appreciated, depending upon the particular implementation, the connection between the application 140 and the execution framework 150 may be direct or indirect. For instance, in an embodiment in which the recommendation system 120 and the execution framework 150 represent dedicated hardware units inside an SoC that can delegate work after it has been submitted to a common queue or pipeline, the connection between the application 140 and the execution framework 150 may go through more layers than depicted in FIG. 1.

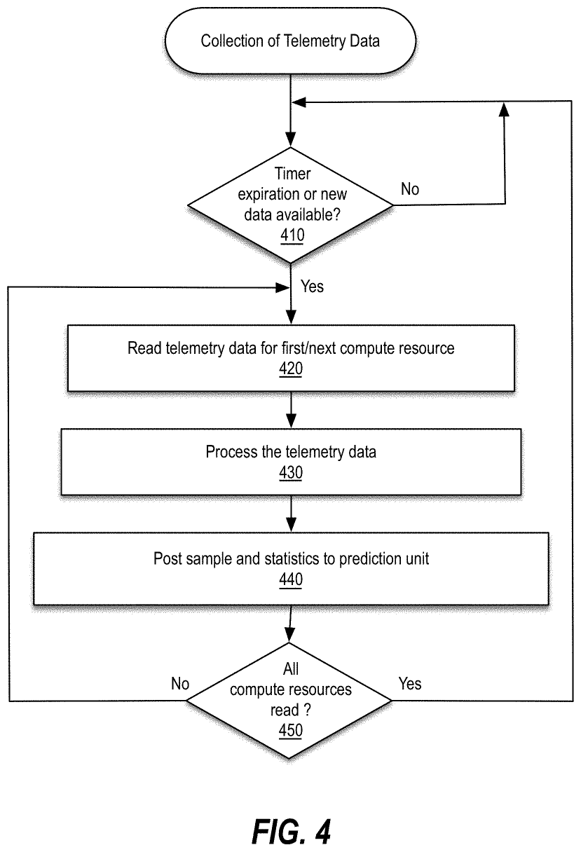

The recommendation system 120 may be responsible for understanding the workload of an application 140 and expectations (e.g., constraints) to recommend the best computer resource to handle the workload at a given time, for example, based on their respective capabilities and utilizations. The exchange of information between the recommendation system 120 and the external entities may be via an application programming interface (API) (not shown) exposed by the recommendation system 120. According to one embodiment, the recommendation system 120 includes a telemetry unit 121, a prediction unit 122, and a recommendation unit 123. The telemetry unit 121 may be responsible for obtaining, processing, and/or storing information received regarding computer resources 160a-n. Non-limiting examples of computer resources 160a-n include a CPU, a GPU, and a VPU. The information obtained regarding the computer resources 160a-n may be obtain directly or indirectly from the computer resources and may include not only information that changes over time (telemetry) but also information that is constant (e.g., properties or capabilities). The telemetry may include hardware (H/W) counters for different parameters, for example, measuring busy state or utilization of an individual computer resource. Alternatively or additionally, parameters may include power consumption, temperature, clock frequency, and/or other variables useful in predicting or affecting workload performance. The information may be collected from an operating system (OS) (e.g., computer resource enumeration), APIs (e.g., one API Level Zero, Open Computing Language (OpenCL)), model specific registers (MSRs), and/or installed services (e.g., the Intel Innovation Platform Framework (IPF)). The telemetry unit 121 may aggregate the information from difference sources for its internal use and/or may make the information available (e.g., in the form of samples) to other units (e.g., the prediction unit 122) of the recommendation system 120. Further details regarding collection of telemetry data are provided below with reference to FIG. 4.

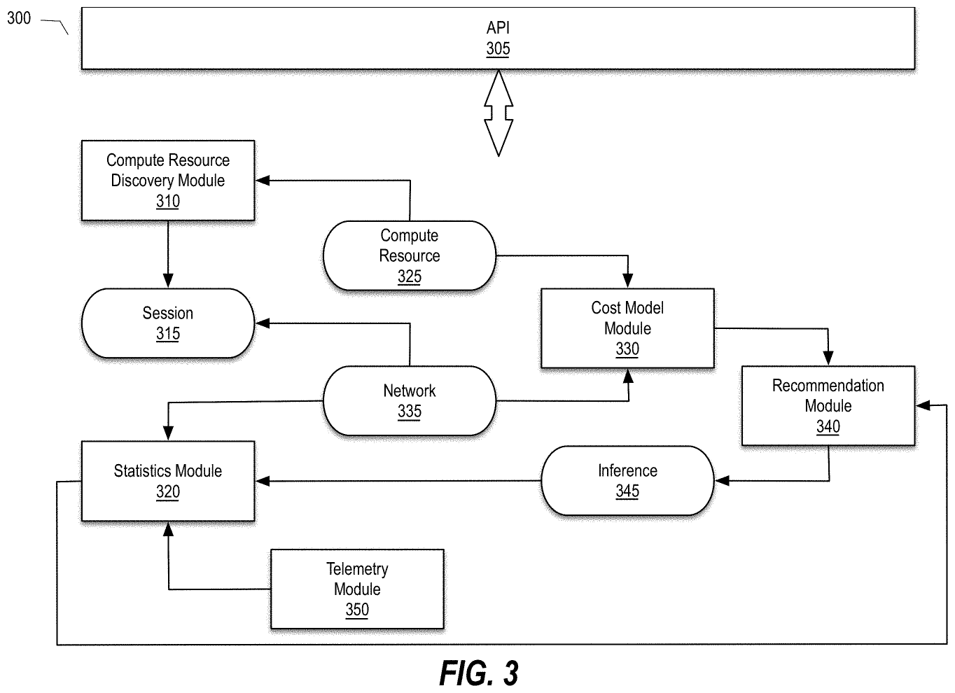

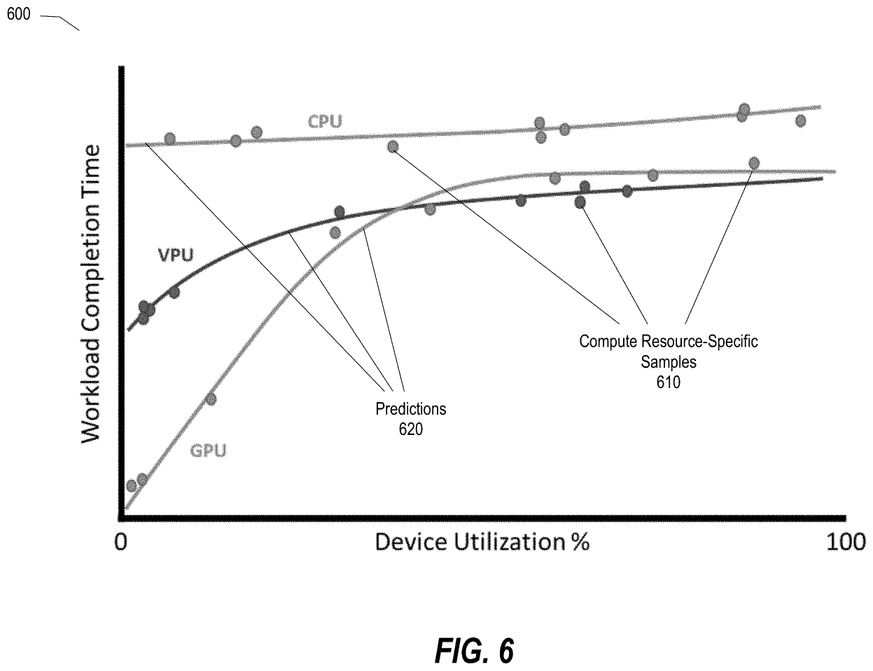

The prediction unit 122 may be responsible for predicting workload performance by each of the computer resources 160a-n for different parameter sets by applying one or more workload performance prediction models (e.g., a cloud-based federated learning model, a statistical model, a local ML model, and/or a network-based synthetic model). For example, the prediction unit 122 may apply statistical regression to samples provided by the telemetry unit to produce a statistical model as described further below with reference to FIG. 6. Alternatively or additionally, the prediction unit 112 may make use of a local ML model created based on the samples and updated or reinforced based on feedback regarding actual performance of a workload reported by the workload executor 155 after completion of a given workload. The network-based synthetic model (which may also be referred to herein as a cost model) may provide a prediction for a given ML inference based on operations required by a particular computer resource in the current state as described further below with reference to the cost model of FIG. 3. In one embodiment, the network-based synthetic model may be used to provide estimates for ML models when there is no knowledge of inference duration or insufficient previous knowledge of inference duration to serve as a reasonable cost estimate.

In one embodiment, the prediction unit 112 may make use of crowd-sourced information (e.g., federated learning input from a federated learning model from the cloud 110) as a backup or redundant source when the samples have poor correlation and/or as an independent input to be aggregated with other workload performance prediction models. The federated learning model may facilitate better prediction by assisting the search of a large search space by providing information regarding how similar workloads have operated on similar computer resources.

The recommendation unit 123 may be responsible for making use of predicted performance provided by the prediction unit 122 to make a computer resource recommendation to the workload executor 155. For example, the recommendation unit 123 may respond to computer resource recommendation requests (e.g., workload steering requests) by scoring and ranking the computer resources 160a-n based on one or more additional constraints specified for a given workload and informing the workload executor of the highest ranked of the computer resources 160a-n given the current conditions (which may vary based on the state of the computer system and/or based on defined optimization goals).

As those skilled in the art will appreciate, there are a number of implementation variants for the recommendation system 120. For example, the recommendation system 120 may be provided as part of a framework bundle in which the recommendation system 120 is implemented as a dynamic link library (DLL). Alternatively, the recommendation system 120 may be implemented external to the execution framework 150, for example, as a system service, thereby allowing it to have system-level information about other scheduled work on the computer resources 160a-n. Other non-limiting implementation variants include implementing the recommendation system 120 as an IPF provider or in a virtualized environment, for example, by exposing a virtual machine (VM) interface to allow connections from VM clients. Depending upon the particular implementation, the recommendation system 120 and execution framework 150 may be associated with the same computer system or different computer systems. A non-limiting example of an internal design representing example modules and example objects that may make up the recommendation system 120 is described below with reference to FIG. 3.

### Example Workload Performance Prediction

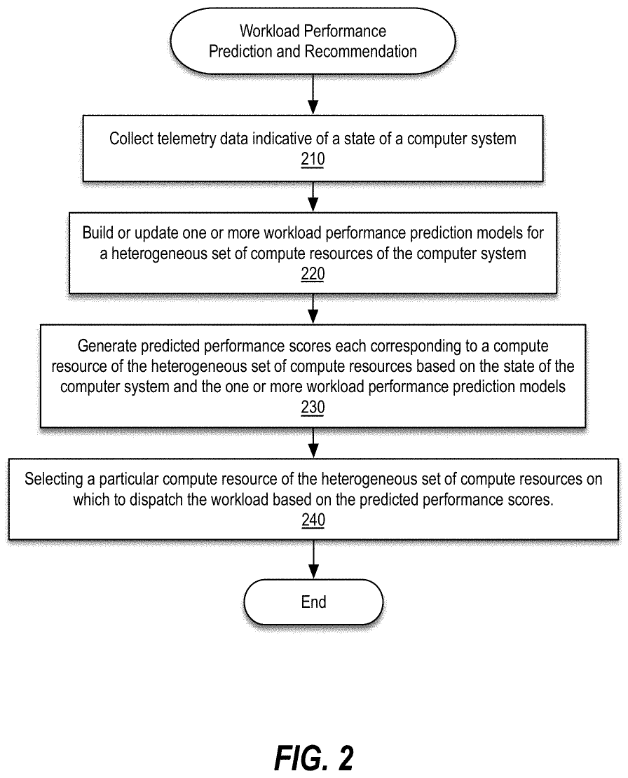

FIG. 2 is a high-level flow diagram illustrating operations for performing workload performance prediction and recommendation according to some embodiments. The processing described with reference to FIG. 2 may be performed by a recommendation system (e.g., recommendation system 120).

At block 210, telemetry data indicative of a state of a computer system are collected. Depending upon the particular implementation and/or the optimization goals, different sets of parameters of a heterogeneous set of computer resources (e.g., computer resources 160a-n) of the computer system may be used to represent the state of the computer system. For example, the state may include availability, utilization, battery status, power consumption, thermal conditions, and/or clock frequency of each of the computer resources. The collection of telemetry data may be performed asynchronously with other processing performed by the recommendation system (e.g., updating workload performance prediction models and scoring and ranking of the computer resources). According to one embodiment, a telemetry unit (e.g., telemetry unit 121) periodically obtains hardware counter data (e.g., measuring one or more of busy state or utilization, power consumption, temperature, clock frequency, and/or other variables useful in predicting or affecting workload performance for each computer resource. The telemetry unit may further convert the data gathered into samples and pass them to a prediction unit (e.g., prediction unit 122) where the samples may be aggregated into a model. A non-limiting example of telemetry data collection and processing is described below with reference to FIG. 4.

At block 220, one or more workload performance prediction models for the heterogeneous set of computer resources may be built or updated based on the telemetry samples. Non-limiting examples of workload performance prediction models that may be utilized by the recommendation system include a cloud-based federated learning model, a local statistical model, a local machine-learning model, and a network-based synthetic. It may be desirable to accumulate a minimum threshold number of samples before performing training of and/or updating the local ML model. As the telemetry samples are received from the telemetry unit, the prediction unit 122 may persist them and determine whether the minimum threshold has been achieved and if so performing training/retraining of the local ML model as appropriate based on the telemetry samples. Alternatively, the local ML model may be trained offline prior to being deployed within the prediction unit. One potential benefit of performing offline training is the ability to capture a higher degree of complexity in terms of relationships among the parameters, which may in turn increase the accuracy of predictions. Until the local ML model is available or meets a certain level of confidence, the prediction unit may rely on other of the workload performance prediction models.

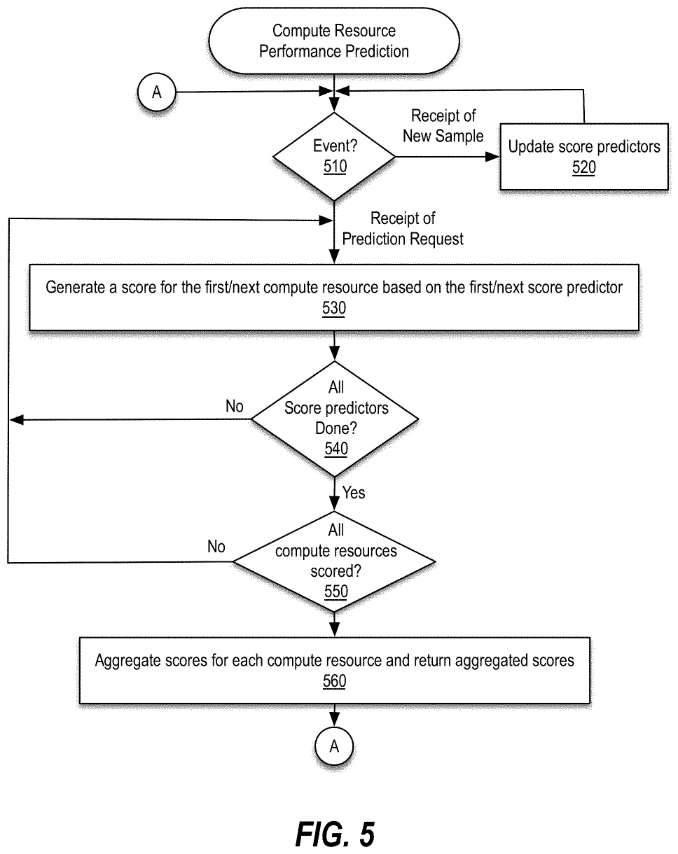

At block 230, predicted performance scores for each computer resource may be generated. For an initial or early estimate (in which there is no or insufficient previous knowledge of inference duration to serve as a cost estimate), the prediction unit may evaluate a cost model for each computer resource based on the state of the individual computer resources and the optimization goal(s) at issue to determine a “cost” (e.g., in terms of time or power) of performing a given workload or type of workload. Depending upon the optimization goal (e.g., performance or power), the cost may be represented accordingly (e.g., time required or power required) by the cost model. Additionally, the prediction unit may apply/evaluate one or more other workload performance prediction models to arrive at an indicator of a predicted workload performance by respective computer resources. For example, a given workload performance prediction model may output a normalized score indicative of a predicted workload performance by each of the computer resources of the heterogeneous set of computer resources, thereby allowing a comparison among the predicted workload performances of individual computer resources. According to one embodiment, the prediction unit uses statistical regression in combination with other techniques (e.g., ML networks) to predict workload performance. A non-limiting example of a graph representing a statistical model that may be produced as a result of application of statistical regression to telemetry samples is described further below with reference to FIG. 6. A non-limiting example of computer resource performance prediction is described below with reference to FIG. 5.

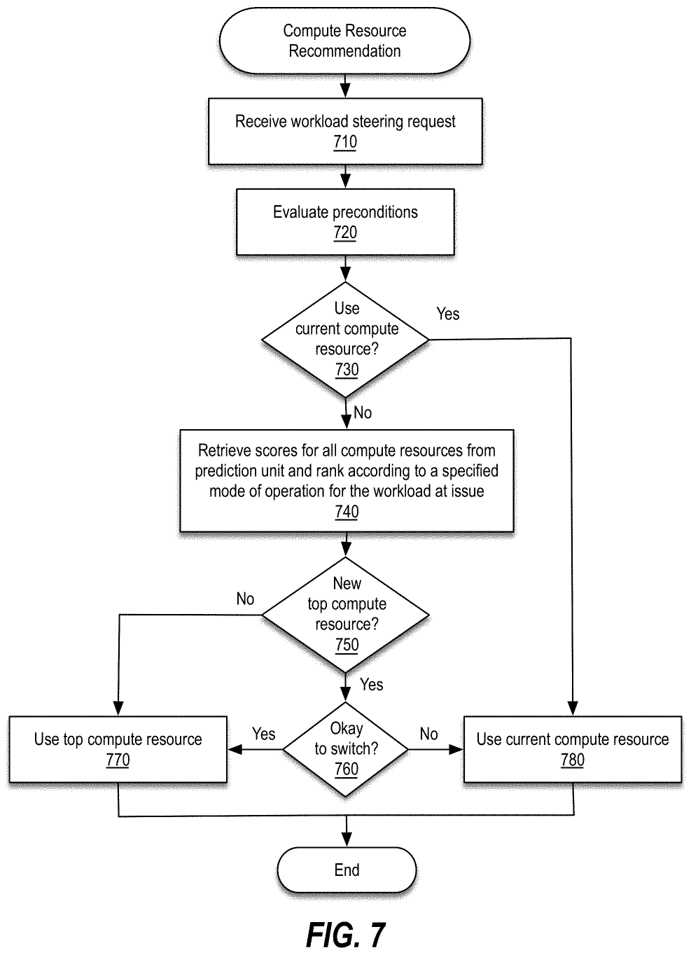

At block 240, a selection is made of a particular computer resource of the heterogeneous set of computer resources on which the workload is to be dispatched based on the predicted performance scores. According to one embodiment, responsive to receipt of a workload steering request from an execution framework (e.g., execution framework 150) a recommendation unit 123 ranks the computer resources based on their respective predicted performance and provides the execution framework with a computer resource recommendation. A non-limiting example of computer resource recommendation is described below with reference to FIG. 7.

While in various examples described herein it is assumed the optimization goal is to maximize performance (e.g., complete execution in the least amount of time or with least latency) of workloads, it is to be understood the optimization goal and corresponding cost models may make use of different parameter sets to achieve other optimization goals (e.g., minimize power consumption, minimize latency, or maximize throughput). In one embodiment, an energy-performance preference (EPP) may be specified in which EPP represents a ratio of energy to performance preference. EPP may be expressed as percentage quartiles in which a value of 0% indicates absolute maximum performance, 100% means maximum power savings, 25% indicates high performance with some consideration to power efficiency, and 50% indicates high power efficiency with some consideration to performance.

### Example Internal Design

FIG. 3 is a block diagram illustrating an internal design 300 according to some embodiments. In the context of the present example, a recommendation service (e.g., recommendation system 120) is made up of various objects (e.g., a session object 315, a computer resource object, a network object 335, and an inference object 345) and modules (e.g., a computer resource discovery module 310, a statistics module 320, a cost model module 330, and a recommendation module 340). The objects represent instances of classes that a client (e.g., execution framework 150) of the recommendation system may use to interact with the recommendation system, whereas the modules may represent separate internal functional blocks. According to one embodiment, interactions with the objects and modules by the client may be performed via an API 305. The proposed architecture attempts to avoid module dependency to allow for different module versions to be used. For example, different code models can be employed to represent different types of workloads.

In the context of the present example, each session object (e.g., session object 315) may represent an instance of a recommendation service for use by a given application (e.g., application 140), typically one per process. Each computer resource object (e.g., computer resource object 325) may represent a given computer resource of a heterogeneous set of computer resources (e.g., computer resources 160a-n) that can be used to perform a task (e.g., an inference in this example). Each network object (e.g., network object 335) may represent a workload to be executed. Each inference object (e.g., inference object 345) may represent an independent workload execution. Multiple inferences can exist and each can be in an active or inactive state of execution.

Turning now to the modules, the recommendation module 340 may be responsible for estimating the computational cost of running a given network in a selected mode (described further below) on each computer resource and applying a set of heuristics to select the best computer resource as the recommended computer resource to be returned to the client. A non-limiting example of computer resource recommendation is described below with reference to FIG. 7.

When the workloads at issue represent ML inferences, the cost model module 330 may represent a network-based synthetic model responsible for making a rough cost estimates (e.g., an initial estimate) for running a given workload on a given computer resource, for example, when insufficient knowledge of inference duration is available to provide reliable predicted performance from one or more other workload performance prediction models. As will be appreciated, when the application starts, there is no previous knowledge of inference duration to serve as a cost estimate. In one embodiment, an initial cost estimate may be generated using the corresponding network object by looking at each layer operation type, tensor shapes, and computer resource parameters to arrive at a computational cost. The cost may be calculated for each layer and added up to represent the network. As will be appreciated by those skilled in the art, the initial cost estimation need not be perfect, but should not be too far off so as to prevent a computer resource from being selected. That is, the initial cost estimation should be close enough to avoid a false negative.

The computer resource discovery module 310 may be responsible for finding the active computer resources in the computer system at issue and querying properties used for the cost model calculation. Table 1 (below) provides a non-limiting set of properties that may be used in connection with calculating a given cost model. Notably, not all of the properties are required. For example, a suitable subset may include the first six properties listed in Table 1. Some properties listed below may be useful but are considered optional, whereas others may provide additional valuable information to the recommendation service.

TABLE 1
Properties for Calculating a Cost Model

| Name | Type | Purpose |
|---|---|---|
| DeviceName | string | Name of the compute |
| | | resource |
| ProviderName | string | Compute resource |
| | | provider name |
| freqBase_Mhz | float | Base frequency in MHz |
| freqMax_Mhz | float | Max frequency in |
| | | megahertz (MHz) |
| powerMax_w | uint32_t | Max power draw in |
| | | Watts |
| DeviceUUID | uint8_t[16] | Compute resource |
| | | universal unique |
| | | identifier (ID) |
| freqRef_Mhz | float | Reference (bus) |
| | | frequency in MHz |
| SupportsFp16 | bool | 16-bit float number full |
| | | support (storage and |
| | | use) |
| SuportsFp16Denormal | bool | Supports fpl6 |
| | | denormals |
| SupportsI8mad | bool | Supports 8-bit integer |
| | | multiply and |
| | | accumulate |
| SupportsUMA | bool | Supports unified |
| | | memory architecture |
| Local_memory_size_MB | uint32_t | Local memory size in |
| | | megabytes (MB) |
| isIntegrated | bool | True if the device is |
| | | integrated with CPU |
| isAccelerator | bool | True if the device is an |
| | | accelerator vs. general |
| | | purpose |
| deviceUniqueID | uint64_t | Unique device ID to |
| | | identify across APIs |
| io_bandwidth_GHz | uint32_t | Memory bandwidth in |
| | | gigahertz (GHz) |
| platform _power_limit_W | uint32_t | Platform power limit in |
| | | Watts |
| power_frequency_bin_count | uint8_t | Number of power and |
| | | frequency bins |
| device_freq_MHZ[MAX_BINS] | uint32_t | Frequencies in MHZ |
| | | the device can operate |
| | | in |
| device_power_W[MAX_BINS] | uint32_t | Power in Watts the |
| | | device consumes at |
| | | each frequency |

The telemetry module 350 may be responsible for providing the service implementation with feedback regarding the state of the computer system (e.g., by performing periodic sampling of hardware counters). The telemetry module may use different ways of accessing the state variables indicative of the state of the computer system depending on the OS facilities and platform architecture. For example, when running within Microsoft Windows, the telemetry module 350 may access state variables via Windows Performance Counters and when the platform includes an Intel processor, the telemetry module 350 may access state variables via IPF. In one embodiment, the overall utilization of a given computer resource may be sampled. Alternatively or additionally, other state variables may be sampled (e.g., representing device power consumption). In one embodiment, the recommendation service attempts to derive the workload specific utilization impact from the overall utilization. As will be appreciated by those skilled in the art, the coarse nature of the overall utilization may make obtaining the workload specific utilization difficult, in particular when the system is under constant transition. For that reason, having access to workload-specific utilization (e.g., per thread or command buffer) may be preferable.

The statistics module 320 may be responsible for receiving submitted samples (e.g., telemetry samples and actual performance) and for generating processed and aggregated information. In one embodiment, the samples come directly from the module that generates them, for example, inference or telemetry samples. One example of aggregated information that may be obtained from the inference and telemetry samples is real inference time (actual performance) and baseline utilization, respectively. This generated data may be consumed by other modules in different ways. For example, the recommendation module 340 may use previous inference data to determine what the real cost is and compare that to the baseline utilization to decide whether the device can handle a given workload.

The API 305 may include functions that may be grouped into four general categories (e.g., initialization, update, query, and cleanup).
Initialization functions may be used to create the various objects use by the recommendation service.
Update functions may be used to change an object's state after it has been created. Additionally, there may be two inference-level functions to log the start and end of a given inference.
Query functions return information to the caller. For example, a function may be provided to return a recommended computer resource for a given workload (e.g., a given inference).
Cleanup functions may be used to destroy the objects created during initializations.

According to one embodiment, there may be multiple modes of operation the recommendation system supports on an interface object:
Background: inferences run infrequently and can be preempted
Fastest: inferences run on the available computer resource that gives the lowest inference latency (fastest inference).
Realtime: inferences should complete in the given amount of time to maintain a frequency. In one embodiment a maximum inference time may be defined representing the maximum time an inference can take in nanoseconds.
Run-once: inferences run infrequently but are expected to complete as fast as possible (i.e., with low latency).

While in the context of the present example, the workload to be executed is assumed to be an ML network, it is to be understood the recommendation service is equally applicable to other types of workloads, including non-ML workloads.

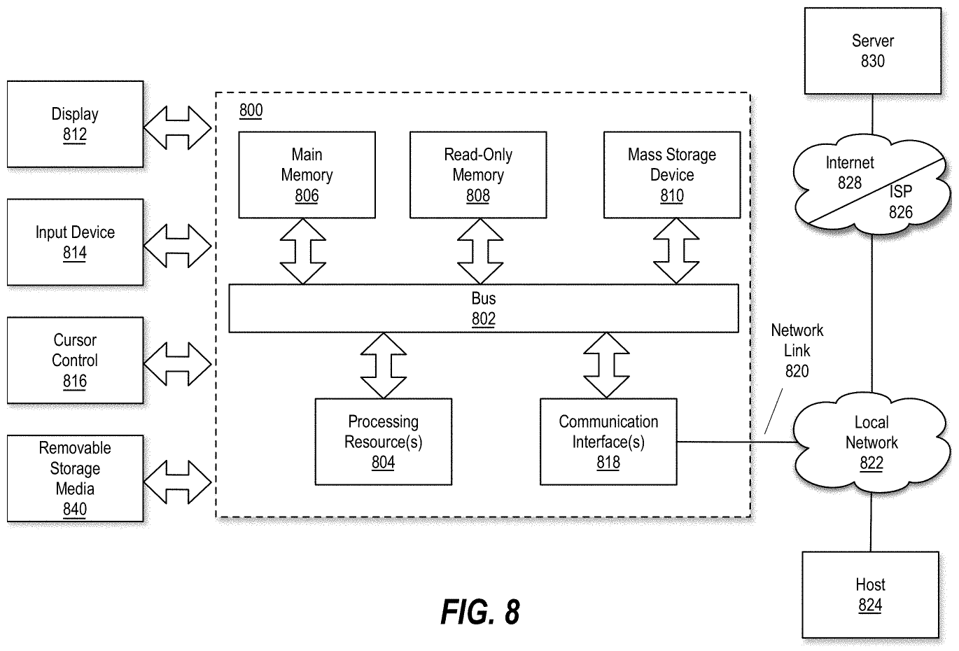

The various modules and units described herein, and the processing described with reference to the flow diagrams of FIGS. 2, 4-5 and -7 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms (such as the computer system described with reference to FIG. 8 below.

### Example Telemetry Data Processing

FIG. 4 is a flow diagram illustrating operations for performing collection of telemetry data according to some embodiments. The processing described with reference to FIG. 4 may be performed by a recommendation system (e.g., recommendation system 120) and more specifically by one or more of a telemetry unit (e.g., telemetry unit 121), a telemetry module (e.g., telemetry module 350), and a statistics module (e.g., statistics module 320).

At decision block 410, it may be determined whether a timer has expired or new data is available. If so processing may continue with block 420; otherwise, processing loops back to decision block 410. In one embodiment, the interval for performing collection of telemetry data may be between about 1 millisecond and 1 second.

At block 420, telemetry data is read for the first/next computer resource of a set of heterogeneous computer resources (e.g., computer resources 160a-n). In one embodiment, the set of heterogeneous computer resources that are available within the platform at issue is identified by prior performance of a discovery process performed by a computer resource discovery module (e.g., computer resource discovery module 310).

At block 430, the telemetry data is processed. According to one embodiment, telemetry samples (e.g., in the form of time-series data points) may be prepared for use by a prediction unit (e.g., prediction unit 122). The generation of telemetry samples from the collected telemetry data may include data cleaning (e.g., substituting missing values with dummy values, substituting the missing numerical values with mean figures, etc.), feature engineering (e.g., the creating of new features out of existing ones), and/or data rescaling (e.g., min-max normalization, decimal scaling, etc.). Additionally, processed and/or aggregated information generated by a statistics module (e.g., statistics module 320) based on the telemetry data may be obtained.

At block 440, a telemetry sample and associated statistics relating to the current computer resource is posted to the prediction unit.

At decision block 450, it is determined whether all computer resources have been read. If so, processing loops back to decision block 410; otherwise, processing continues with the next computer resource by looping back to block 420.

### Example Compute Resource Performance Prediction

FIG. 5 is a flow diagram illustrating operations for performing computer resource performance prediction according to some embodiments. The processing described with reference to FIG. 5 may be performed by recommendation system (e.g., recommendation system 120) and more specifically by a prediction unit (e.g., prediction unit 122) based on one or more workload performance prediction models, non-limiting examples of which may include a cloud-based federated learning model, a local statistical model, a local machine-learning model, and/or a network-based synthetic model (e.g., a cost model represented by cost model module 330).

At decision block 510, a determination is made regarding the event that triggered the computer resource performance prediction. If the event represents the receipt of a prediction request from a caller (e.g., from the recommendation unit 123 or the recommendation module 340), processing continues with block 530; otherwise, if the event represents receipt of a new sample from a caller (e.g., a new telemetry sample or actual performance), processing branches to block 520.

At block 520, score predictors are updated. For example, one or more of the workload performance prediction models may be trained or updated/retrained as appropriate depending on the particular implementation and model at issue. After block 520, processing loops back to decision block 510 to process the next event.

At block 530, a score is generated for the first/next computer resource based on the first/next score predictor. Depending upon the particular implementation, the score may be a single value or a multidimensional value that includes performance, power, latency and other parameters. In one embodiment, the score may be generated obtaining a predicted/estimated workload performance (e.g., execution time) of the current computer resource from the current score predictor. For example, if the current score predictor is the local ML model, then an inference regarding workload performance for the current computer resource may be obtained from the local ML model based on the current state of the computer resource (e.g., utilization). If the score predictor at issue is the local statistical model, the current state of the computer resource may be used to calculate the workload performance for the computer resource based on the local statistical model. As noted above, while multiple workload performance prediction models may be available, not all may be active at a given time, for example, due to poor correlation of telemetry samples (e.g., translating into low confidence by the local ML model), the cloud-based federated learning model may be used instead of the local ML model. Alternatively or additionally, early estimates may be obtained from a cost model.

At decision block 540, it is determined whether all score predictors are done. If so, processing continues with decision block 550; otherwise, processing loops back to block 530 to generate a score for the current computer resource using the next score predictor.

At decision block 550, it is determined whether all computer resources have been scored. If so, processing continues with block 560; otherwise, processing loops back to block 530 to generate a score for the next computer resource using the first score predictor.

At block 560, the scores for each computer resource may be aggregated and returned to the caller as an indication of a predicted performance for each computer resource. Depending upon the particular embodiment, the aggregation of the scores for an individual computer resource may involve selecting a score deemed most representative from among the scores generated by the score predictors, calculating an average (or weighted average) score based on all scores generated by the score predictors for a given computer resource, or simply summing the scores for each individual computer resource to produce a total of all scores generated by the score predictors for each computer resource. After block 560, processing loops back to decision block 510 to process the next event.

### Example Statistical Model

FIG. 6 is a graph 600 illustrating an example of regression of computer-resource-specific samples 510 to predict an optimization goal based on a state of a computer system according to some embodiments. In the context of the present example, computer-resource-specific samples 510 indicative of actual performance (e.g., workload completion time) of a heterogeneous set of computer resources (e.g., computer resources 160a-n), including a CPU, a VPU, and a GPU, for various states (e.g., utilization percentages) have been regressed to generate corresponding predictions 520 that can be used to predicting workload completion time for a range of system states. In this example, it can be seen based on the prior samples of actual performance by the CPU, the VPU, and the GPU, for all values of device utilization, the predicted workload completion time for the CPU is greater than that of the VPU and the GPU. Additionally, the predicted workload completion time for the GPU is lower than that of the VPU until about 25% device utilization at which point the predicted workload completion time for the VPU is lower than that of the GPU.

### Example Compute Resource Recommendation

FIG. 7 is a flow diagram illustrating operations for performing computer resource recommendation according to some embodiments. The processing described with reference to FIG. 7 may be performed by recommendation system (e.g., recommendation system 120) and more specifically one or more of a recommendation unit (e.g., recommendation unit 123) and a recommendation module (e.g., recommendation module 340).

At block 710, a workload steering request is received by the recommendation system, for example, from an execution framework (e.g., execution framework 150). In one embodiment, the workload steering request represents a query issued by a workload executor (e.g., workload executor 155) to the recommendation system via an API (e.g., API 305) exposed by the recommendation system. For example, the workload executor may issue a query for a recommended computer resource for a given workload and provide information regarding one or more additional constraints to be taken into consideration as part of the recommendation. For instance, in the context of a video playback application (e.g., application 140) that generates a super resolution video stream, the application may request the recommendation system to recommend the best computer resource among a heterogeneous set of computer resources (e.g., computer resources 160a-n) that is also capable of meeting a minimum frames per second (FPS) constraint (e.g., 15 FPS).

At block 720, preconditions may be evaluated. According to one embodiment, a set of candidate computer resources may be created based on evaluation of the preconditions. The preconditions may include, for example, whether a given computer resource has certain device capabilities and/or has sufficient unused computer capacity to meet any constraints specified by the application and communicated to the recommendation system at block 710. As a result of evaluating the preconditions it may be determined, for example, only one computer resource is a candidate for the workload at issue or that a recommendation request for the same workload thread has been received without active inferences having been recorded since the last recommendation request. In such cases, the recommendation system can recommend the one computer resource or the last recommendation, respectively.

At decision block 730, it is determined whether the current computer resource is to be used. If so, processing branches to block 780; otherwise, processing continues with block 740. As noted above, this determination may be based on the candidate computer resource(s) that meet specified contains and/or whether it is too soon for the prior computer resource recommendation to have changed.

At block 740, the scores (e.g., representing respective relative predicted workload performance) for all computer resources are retrieved from a prediction unit (e.g., prediction unit 122) and the candidate computer resources are ranked. For example, the computer resources may be ranked in decreasing order of performance in which the top rated computer resource is predicted to have the best workload performance. In one embodiment, the ranking of the computer resources may take into consideration a mode of operation of the workload, for example, the application may specify a given inference may be performed in accordance with one of multiple modes of operation (e.g., background, fastest, real-time, or run-once). The fastest mode of operation may be analogous to throughput or performance. The run-once mode of operation may be analogous to low latency. The real-time mode of operation may be used for periodic workloads, for example, that may prefer the cheapest computer resource that meets the performance goal (versus maximum performance). The background mode of operation may map to a low power mode.

At decision block 750, it is determined whether there is a new top computer resource since the last recommendation. If so, processing continues with decision block 760; otherwise, processing branches to block 770.

At decision block 760, it is determined whether it is okay to switch from a currently used computer resource to the top ranked computer resource. If so, processing continues with block 770; otherwise processing branches to block 780. Depending on the particular implementation, this determination may involve evaluating if the score gain from switching is sufficient and/or whether enough time has passed since the last switch.

At block 770, the top ranked computer resource is returned to the caller as the recommended computer resource for the workload steering request received at block 710 and computer resource recommendation processing is complete.

At block 780, the current computer resource is returned to the caller as the recommended computer resource for the workload steering request received at block 710 and computer resource recommendation processing is complete.

As will be appreciated with reference to the processing described with reference to FIG. 7, a sequence of similar workloads (e.g., ML inferences) may be steered to different computer resources based on changing system state (e.g., an intervening workload being started on the system that causes the utilization of a former top computer resource to increase) resulting in a change in relative rankings of the computer resources.

While in the context of the flow diagrams presented herein, a number of enumerated blocks are included, it is to be understood that the examples may include additional blocks before, after, and/or in between the enumerated blocks. Similarly, in some examples, one or more of the enumerated blocks may be omitted or performed in a different order.

### Example Computer System

FIG. 8 is an example of a computer system 800 with which some embodiments may be utilized. Notably, components of computer system 800 described herein are meant only to exemplify various possibilities. In no way should example computer system 800 limit the scope of the present disclosure. In the context of the present example, computer system 800 includes a bus 802 or other communication mechanism for communicating information, and one or more processing resources 804 coupled with bus 802 for processing information. The processing resources may be, for example, a combination of one or more computer resources (e.g., a microcontroller, a microprocessor, a CPU, a CPU core, a GPU, a GPU core, a VPU, an ASIC, an FPGA, or the like) or a system on a chip (SoC) integrated circuit. Referring back to FIG. 1, the computer resources 160a-n may be analogous to a heterogeneous set of computer resources representing processing resources 804.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, e.g., a magnetic disk, optical disk or flash disk (made of flash memory chips), is provided and coupled to bus 802 for storing information and instructions.

Computer system 800 may be coupled via bus 802 to a display 812, e.g., a cathode ray tube (CRT), Liquid Crystal Display (LCD), Organic Light-Emitting Diode Display (OLED), Digital Light Processing Display (DLP) or the like, for displaying information to a computer user. An input device 814, including alphanumeric and other keys, is coupled to bus 802 for communicating information and command selections to processor 804. Another type of user input device is cursor control 816, such as a mouse, a trackball, a trackpad, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Removable storage media 840 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 800 may implement the techniques described herein using customized hard-wired logic, one or more ASICs or FPGAs, firmware or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 810. Volatile media includes dynamic memory, such as main memory 806. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes interface circuitry 818 coupled to bus 802. The interface circuitry 818 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. As such, interface 818 may couple the processing resource in communication with one or more discrete accelerators 805 (e.g., one or more XPUs).

Interface 818 may also provide a two-way data communication coupling to a network link 820 that is connected to a local network 822. For example, interface 818 may be an integrated services digital network (ISDN) card, cable modem, satellite modem, or a modem to provide a data communication connection to a corresponding type of telephone line. As another example, interface 818 may be a local area network (LAN) card to provide a data communication connection to a compatible LAN. Wireless links may also be implemented. In any such implementation, interface 818 may send and receive electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the worldwide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818. The received code may be executed by processor 804 as it is received, or stored in storage device 810, or other non-volatile storage for later execution.

While many of the methods may be described herein in a basic form, it is to be noted that processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that includes a non-transitory machine-readable medium storing instructions, which when executed by a processing resource of a computer system cause the processing resource to: based on telemetry samples collected from the computer system or a second computer system in real-time and indicative of a state of the computer system or the second computer system, build or update one or more workload performance prediction models for a set of computer resources of the computer system or the second computer system with reference to one or more optimization goals; at a time of execution of a workload, determine a particular computer resource of the set of computer resources on which to dispatch the workload by: generating at least one predicted performance score corresponding to a computer resource of the set of computer resources based on the state of the computer system and the one or more workload performance prediction models; and selecting the particular computer resource based on the predicted performance score.

Example 2 includes the subject matter of Example 1, wherein the telemetry samples comprise computer utilization for each computer resource of the set of computer resources.

Example 3 includes the subject matter of any of Examples 1-2, wherein the telemetry samples include one or more of hardware properties and hardware counters.

Example 4 includes the subject matter of Example 3, wherein the hardware properties comprise one or more of a base frequency of a given computer resource of the plurality of computer resources, a maximum frequency of the given computer resource, a maximum power draw of the given computer resource, and a size of a local memory of the given computer resource.

Example 5 includes the subject matter of any of Examples 1-4, wherein the one or more workload performance prediction models include a plurality of: a cloud-based federated learning model; a statistical model; a local machine-learning model; and a network-based synthetic model.

Example 6 includes the subject matter of Example 5, wherein the instructions further cause the processing resource to: determine an actual workload performance for a given workload that has completed execution on a given computer resource of the set of computer resources; and cause the one or more workload performance prediction models to be updated based on the actual workload performance.

Example 7 includes the subject matter of any of Examples 1-6, wherein the one or more optimization goals comprise completing execution of a given workload by the computer system or the second computer system in a least amount of time.

Example 8 includes the subject matter of any of Examples 1-7, wherein the one or more optimization goals comprises completing execution of a given workload while utilizing a least amount of power by the computer system.

Example 9 includes the subject matter of any of Examples 1-8, wherein the one or more optimization goals comprises completing execution of a given workload while maintaining a predefined or configurable ratio of power consumption to performance.

Example 10 includes the subject matter of any of Examples 1-9, wherein the set of computer resources include a central processing unit (CPU), a graphics processing unit (GPU), and a vision processing unit (VPU).

Some embodiments pertain to Example 11 that includes a method comprising: based on telemetry samples collected from a computer system in real-time and indicative of a state of the computer system, building or updating one or more workload performance prediction models for a set of computer resources of the computer system with reference to one or more optimization goals; at a time of execution of a workload, determining a particular computer resource of the heterogeneous set of computer resources on which to dispatch the workload by: generating at least one predicted performance score corresponding to a computer resource of the set of computer resources based on the state of the computer system and the one or more workload performance prediction models; and selecting the particular computer resource based on the predicted performance score.

Example 12 includes the subject matter of Example 11, wherein the telemetry samples comprise computer utilization for each computer resource of the set of computer resources.

Example 13 includes the subject matter of any of Examples 11-12, wherein the telemetry samples include one or more of hardware properties and hardware counters.

Example 14 includes the subject matter of Example 13, wherein the hardware properties comprise one or more of a base frequency of a given computer resource of the plurality of computer resources, a maximum frequency of the given computer resource, a maximum power draw of the given computer resource, and a size of a local memory of the given computer resource.

Example 15 includes the subject matter of any of Examples 11-15, wherein the one or more workload performance prediction models include a plurality of: a cloud-based federated learning model; a statistical model; a local machine-learning model; and a network-based synthetic model.

Example 16 includes the subject matter of Example 15, further comprising: determining an actual workload performance for a given workload that has completed execution on a given computer resource of the set of computer resources; and causing the one or more workload performance prediction models to be updated based on the actual workload performance.

Example 17 includes the subject matter of any of Examples 11-16, wherein the one or more optimization goals comprise completing execution of a given workload by the computer system in a least amount of time.

Example 18 includes the subject matter of any of Examples 11-17, wherein the one or more optimization goals comprises completing execution of a given workload while utilizing a least amount of power by the computer system.

Example 19 includes the subject matter of any of Examples 11-18, wherein the one or more optimization goals comprises completing execution of a given workload while maintaining a predefined or configurable ratio of power consumption to performance.

Example 20 includes the subject matter of any of Examples 11-19, wherein the set of computer resources include a central processing unit (CPU), a graphics processing unit (GPU), and a vision processing unit (VPU).

Some embodiments pertain to Example 21 that includes a computer system comprising: a processing resource; and instructions, which when executed by the processing resource cause the processing resource to: based on telemetry samples collected from the computer system or a second computer system in real-time and indicative of a state of the computer system or the second computer system, build or update one or more workload performance prediction models for a heterogeneous set of computer resources of the computer system or the second computer system with reference to one or more optimization goals; at a time of execution of a workload, dynamically determine a particular computer resource of the heterogeneous set of computer resources on which to dispatch the workload by: generating a plurality of predicted performance scores each corresponding to a computer resource of the heterogeneous set of computer resources based on the state of the computer system and the one or more workload performance prediction models; and selecting the particular computer resource based on the plurality of predicted performance scores.

Example 22 includes the subject matter of Example 21, wherein the telemetry samples comprise computer utilization for each computer resource of the heterogenous set of computer resources.

Example 23 includes the subject matter of any of Examples 21-22, wherein the one or more workload performance prediction models include a plurality of: a cloud-based federated learning model; a statistical model; a local machine-learning model; and a network-based synthetic model.

Example 24 includes the subject matter of Example 23, wherein the instructions further cause the processing resource to: determine an actual workload performance for a given workload that has completed execution on a given computer resource of the heterogeneous set of computer resources; and cause the one or more workload performance prediction models to be updated based on the actual workload performance.

Example 25 includes the subject matter of any of Examples 21-24, wherein the one or more optimization goals comprise completing execution of a given workload by the computer system or the second computer system in a least amount of time or completing execution of a given workload while utilizing a least amount of power by the computer system.

Some embodiments pertain to Example 26 that includes an apparatus that implements or performs a method of any of Examples 11-20.

Example 27 includes at least one machine-readable medium comprising a plurality of instructions, when executed on a computing device, implement or perform a method or realize an apparatus as described in any preceding Example.

Example 29 includes an apparatus comprising means for performing a method as claimed in any of Examples 11-20.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A non-transitory machine-readable medium storing instructions, which when executed by a processing resource of a computer system cause the processing resource to:
based on telemetry samples collected from the computer system or a second computer system in real-time and indicative of a state of the computer system or the second computer system, build or update one or more workload performance prediction models for a set of computer resources of the computer system or the second computer system with reference to one or more optimization goals;
at a time of execution of a workload, determine a particular computer resource of the set of computer resources on which to dispatch the workload by:
generating at least one predicted performance score corresponding to a computer resource of the set of computer resources based on the state of the computer system and the one or more workload performance prediction models; and
selecting the particular computer resource based on the predicted performance score.

2. The non-transitory machine-readable medium of claim 1, wherein the telemetry samples comprise computer utilization for each computer resource of the set of computer resources.

3. The non-transitory machine-readable medium of claim 1, wherein the telemetry samples include one or more of hardware properties and hardware counters.

4. The non-transitory machine-readable medium of claim 3, wherein the hardware properties comprise one or more of a base frequency of a given computer resource of the plurality of computer resources, a maximum frequency of the given computer resource, a maximum power draw of the given computer resource, and a size of a local memory of the given computer resource.

5. The non-transitory machine-readable medium of claim 1, wherein the one or more workload performance prediction models include a plurality of:
a cloud-based federated learning model;
a statistical model;
a local machine-learning model; and
a network-based synthetic model.

6. The non-transitory machine-readable medium of claim 5, wherein the instructions further cause the processing resource to:
determine an actual workload performance for a given workload that has completed execution on a given computer resource of the set of computer resources; and
cause the one or more workload performance prediction models to be updated based on the actual workload performance.

7. The non-transitory machine-readable medium of claim 1, wherein the one or more optimization goals comprise completing execution of a given workload by the computer system or the second computer system in a least amount of time.

8. The non-transitory machine-readable medium of claim 1, wherein the one or more optimization goals comprises completing execution of a given workload while utilizing a least amount of power by the computer system.

9. The non-transitory machine-readable medium of claim 1, wherein the one or more optimization goals comprises completing execution of a given workload while maintaining a predefined or configurable ratio of power consumption to performance.

10. The non-transitory machine-readable medium of claim 1, wherein the set of computer resources include a central processing unit (CPU), a graphics processing unit (GPU), and a vision processing unit (VPU).

11. A method comprising:
based on telemetry samples collected from a computer system in real-time and indicative of a state of the computer system, building or updating one or more workload performance prediction models for a set of computer resources of the computer system with reference to one or more optimization goals;
at a time of execution of a workload, determining a particular computer resource of the set of computer resources on which to dispatch the workload by:
generating at least one predicted performance score corresponding to a computer resource of the set of computer resources based on the state of the computer system and the one or more workload performance prediction models; and
selecting the particular computer resource based on the predicted performance score.

12. The method of claim 11, wherein the telemetry samples comprise computer utilization for each computer resource of the set of computer resources.

13. The method of claim 11, wherein the telemetry samples include one or more of hardware properties and hardware counters.

14. The method of claim 13, wherein the hardware properties comprise one or more of a base frequency of a given computer resource of the plurality of computer resources, a maximum frequency of the given computer resource, a maximum power draw of the given computer resource, and a size of a local memory of the given computer resource.

15. The method of claim 11, wherein the one or more workload performance prediction models include a plurality of:
a cloud-based federated learning model;
a statistical model;
a local machine-learning model; and
a network-based synthetic model.

16. The method of claim 15, further comprising:
determining an actual workload performance for a given workload that has completed execution on a given computer resource of the set of computer resources; and
causing the one or more workload performance prediction models to be updated based on the actual workload performance.

17. The method of claim 11, wherein the one or more optimization goals comprise completing execution of a given workload by the computer system in a least amount of time.

18. The method of claim 11, wherein the one or more optimization goals comprises completing execution of a given workload while utilizing a least amount of power by the computer system.

19. The method of claim 11, wherein the one or more optimization goals comprises completing execution of a given workload while maintaining a predefined or configurable ratio of power consumption to performance.

20. The method of claim 11, wherein the set of computer resources include a central processing unit (CPU), a graphics processing unit (GPU), and a vision processing unit (VPU).

21. A computer system comprising:
a processing resource; and
instructions, which when executed by the processing resource cause the processing resource to:
based on telemetry samples collected from the computer system or a second computer system in real-time and indicative of a state of the computer system or the second computer system, build or update one or more workload performance prediction models for a heterogeneous set of computer resources of the computer system or the second computer system with reference to one or more optimization goals;
at a time of execution of a workload, dynamically determine a particular computer resource of the heterogeneous set of computer resources on which to dispatch the workload by:
generating a plurality of predicted performance scores each corresponding to a computer resource of the heterogeneous set of computer resources based on the state of the computer system and the one or more workload performance prediction models; and
selecting the particular computer resource based on the plurality of predicted performance scores.

22. The computer system of claim 21, wherein the telemetry samples comprise computer utilization for each computer resource of the heterogenous set of computer resources.

23. The computer system of claim 21, wherein the one or more workload performance prediction models include a plurality of:
a cloud-based federated learning model;
a statistical model;
a local machine-learning model; and
a network-based synthetic model.

24. The computer system of claim 23, wherein the instructions further cause the processing resource to:
determine an actual workload performance for a given workload that has completed execution on a given computer resource of the heterogeneous set of computer resources; and
cause the one or more workload performance prediction models to be updated based on the actual workload performance.

25. The computer system of claim 21, wherein the one or more optimization goals comprise completing execution of a given workload by the computer system or the second computer system in a least amount of time or completing execution of a given workload while utilizing a least amount of power by the computer system.
